(19) United States
(12) Patent Application Publication
(10) Pub. No.: US 2002/0064285 A1
(43) Pub. Date: May 30, 2002

(54) System and method for processing an audio signal prior to encoding

(76) Inventor: Roland H. DeLeon, San Antonio, TX (US)

Correspondence Address: John H. D'Antico, Brobeck, Phleger & Harrison LLP, 4801 Plaza on the Lake, Austin, TX, 78746, US

(21) Appl. No.: 09/858,203

(22) Filed: May 15, 2001

Related U.S. Application Data
(60) Provisional application No. 60/250,275, filed on Nov. 30, 2000.

(51) Int. Cl. G06F 17/00; H04R 5/00

(52) U.S. Cl. 381/56; 700/94; 381/23; 381/106; 704/500; 704/503

(57) ABSTRACT

The present invention comprises methods and systems for a dynamic audio processor for processing an audio signal prior to encoding. The audio signal is pre-processed to provide analog-to-analog modification that creates a preferred analog format that is effectively and efficiently ready to be converted into a digital data stream by an encoder, such as an A-to-D converter or codec. One possible application includes, for example, a web streamer that provides digital data streams from a server. The inventive arrangements are preferably carried by functional stand-alone components, integral components of a PC or other computing platform, or carried as part of the encoder. Preferably, the pre-processing comprises receiving the audio signal, nominalizing the signal to provide a level input, and compressing and equalizing the signal for outputting thereof.

### CROSS-REFERENCES TO RELATED APPLICATIONS

This application claims the benefit of Provisional Patent Application Serial No. 60/250,275, filed Nov. 30, 2000.

### BACKGROUND OF THE INVENTION

1. Field of the Invention

This invention relates generally to signal processing, and more particularly, for example, but not by way of limitation, to a system and method for processing an audio signal prior to encoding said audio signal.

2. Description of Related Art

Sound is enabled by variations in air pressure. These variations, called sound waves, can be converted into analog electrical signals, the voltage of which depends upon, among other things, the frequency or pitch of the sound wave as well as its pressure (i.e., its volume). Conversion of an analog sound wave into a digital electrical signal is commonly accomplished by an analog-to-digital (“A-to-D”) converter, which converts the analog voltage of the analog sound wave into a binary (digital) number that is generally in the form of one or more “on” or “off” electrical pulses. Thus, the A-to-D converter provides a digital data stream that is assembled into data packets by a packetizer for distribution, for example, over various intranets or internets, such as a local area network (“LAN”), wide area network (“WAN”), Internet, wireless network, or other. As such, the A-to-D converter is commonly referred to as an “encoder” or “coder.”

Conversion of the digital electrical signal back into an analog sound wave is commonly accomplished by a digital-to-analog (“D-to-A”) converter, which converts the digital data stream into various voltage levels that are fed to an amplifier and ultimately speakers, thus reproducing audible sound waves. As such, the D-to-A converter is commonly referred to as a “decoder.” The coder and decoder are commonly carried on a sound card in a personal computer (“PC”) or other computer platform, such as a personal digital assistant (“PDA”), and a combination coder-decoder (“codec”) includes both an A-to-D converter and a D-to-A converter.

Sophisticated recording technologies, such as compact discs (“CD”), attempt to create recordings of analog sound waves with perfect fidelity and perfect reproduction. Fidelity is a measure of similarity between the original sound wave and the reproduced signal. Reproduction is a measure of the way the recording sounds every time that it is played, regardless of how many times it is played. Provided the encoded data stream of numbers is not corrupted, the analog wave reproduced by the D-to-A converter will be the same every time. The analog wave reproduced by the D-to-A converter will also be very similar to the original analog wave if the A-to-D converter sampled the original analog wave at a high rate and recorded accurate voltage levels corresponding to the original analog wave. Thus, A-to-D converters are often characterized by two variables. The first variable is the sampling rate, measuring the number of samples taken per unit of time, frequently measured per second. The second variable is sampling precision, measuring the number of gradations or distinct voltage levels that are recognized during sampling. For example, at a sampling rate of 1,000 samples per second and a sampling precision of 10, the A-to-D converter samples the voltage of the analog wave every 1/1000th of a second and selects a number between 0 and 9 that is closest in proximity to the measured voltage that is representative of the analog wave. The series of numbers 0-9, first converted into a binary representation thereof, comprise the aforementioned digital representation of the original wave, which will be decoded by the D-to-A converter upon analog playback.

If the sampling rate and sampling precision are low, the reproduced analog signal will lose much of the data contained in the original analog sound wave, resulting in poor fidelity. This is commonly called “sampling error.” Sampling error is reduced by increasing both the sampling rate and sampling precision. For example, at a sampling rate of 2,000 samples per second and sampling precision of 20, the A-to-D converter samples the analog wave 2,000 times every second and selects a number between 0 and 20 that is closest in proximity to the voltage of the analog wave. Upon playback, the resulting wave will have decreased sampling error compared to sampling at 10 gradations and a sampling rate of 1,000 samples per second, but increased sampling error compared to sampling at 40 gradations and a sampling rate of 4,000 samples per second. Thus, as the sampling rate and sampling precision generally increase, sampling error decreases, thereby increasing fidelity.

For CD quality sound, the A-to-D converter sampling rate is 44,100 samples per second and each sample is commonly converted into a 16-bit number, corresponding to one of 65,536 gradations or distinct voltage levels. At this sampling rate and sampling precision, the output of the D-to-A converter so closely matches the original analog wave that the sound is essentially “perfect” to most human ears. However, most sound files containing such data are enormous, and often remain so even after being compressed. Thus, most sound files require a data transfer rate of at least 700 kilobytes per second (“kbps”) to be played in real-time, and with stereophonic sound files, the required data transfer rate doubles to at least 1,400 kbps.

Since the advent of the modern Internet, users often desire to listen to talk radio stations, interviews, sound clips, musical radio stations, and much more from their PCs and computing platforms. In fact, these services are commonly demanded both live and on-demand. However, since typical access to the Internet is limited to data transfer rates of 28.8 kbps, most sound files are too large to be delivered in real-time through an Internet-enabled network. For example, it can take over fifteen minutes to download a one minute sound file. Simple solutions, such as reducing the sampling rate to 8,000 samples per second or using 8-bit samples, result in greatly inferior sound quality; even still, such sound files still require data transfer rates of 64 kbps even for monophonic sound files, unfortunately greatly exceeding the Internet's current data transfer rates.

Thus, streaming technologies were introduced as a welcome solution to the above problems. With streaming audio, for example, an entire sound file need not be downloaded before listening can begin. Rather, the sound file is played and listened to as it is downloaded. More specifically, the sound file is sent as sequential data packets to a buffer in an end user's PC or other computing platform. When the buffer is full, which often requires no more than a few seconds, an audio player begins playing the sound file. As the sound file is played, additional data packets are delivered to the buffer, and as the buffer continues to receive the additional data packets for near-simultaneous playback, the entire sound file is thereby played in its entirety. After being played, each data packet is generally discarded, and the entire sound file may never exist in its entirety at the end user's PC or other computing platform.

Heretofore, however, sound quality continued to be a problem with most streaming audio applications. For example, the data packets comprising sound files are ordinarily transmitted using a User Datagram Protocol (“UDP”) instead of the Internet's ordinary Transmission Control Protocol (“TCP”). Unlike TCP, UDP does not re-transmit un-received packets; if it did, the end user's sound player would be constantly bombarded with re-transmitted packets, effectively hampering audible playback of the sound file.

Thus, to be used effectively on the Internet, playback sound quality needs to at least reach the level of an FM radio broadcast, yet still be able to be transmitted at a data transfer rate of 28.8 kbps. Heretofore, many prior art solutions focused on increasing the bandwidth of Internet transmission, thereby enabling more data to be transferred per unit time. Other solutions focus on using digital signal processors (“DSPs”) to alter playback after the analog sound wave has been encoded by the A-to-D converter. In addition, a variety of compression schemes, using complex mathematical methods and models, are used to approximate the analog signal.

Some compression technologies achieve modest sound quality at relatively low data transfer rates. However, to be used more effectively with real-time streaming delivery, for example, other factors must also be considered in order to provide for the highest quality end user experience. For instance, the speed of encoding and decoding, tolerance to lost data, and scalable audio quality are additional factors that are often overlooked.

The speed of encoding and decoding data is important because many time constraints are often placed on PC content conversion. Moreover, this speed is also of paramount importance in any live, real-time encoding application, which could involve multiple and simultaneous data transfer rates. Thus, although sophisticated mathematical algorithms can be employed to produce a quality return, the net gain in quality must be compared with the required encoding complexity. For example, if 50% or more of a PC's computing resources are required for a particular algorithmic compression scheme that yields only a 5% increase in playback quality, the algorithm may over-tax the PC's resources for most applications. As commonly recognized, such solutions thus remain viable only if unlimited computing resources are available. On the other hand, using algorithms that are too low in complexity result in poor audio quality. Thus, rather than limitlessly increase computational complexity at the expense of limited computing resources, what is needed is a technology that can implement a most preferred algorithm per computing cycle so as to increase the speed of encoding and decoding.

Secondly, tolerance to lost data is often overlooked. To be sure, streaming media technologies encounter many challenges that were not encountered by traditional networking media distribution technologies. For example, streaming audio is transmitted in real-time and thus, when information is lost, a server is often not available to retransmit un-received data packets. This has created the need for a “best efforts” UDP. Best efforts delivery mechanisms, combined with the inherent data packet losses that are inevitable on a public network, such as the Internet, suggest that missing audio data is unavoidable in Internet streaming. However, most present day A-to-D converters were not specifically designed for streaming data packets. Thus, while many compression algorithms employ predictive algorithms that use past data to compensate for lost data, such algorithms often require access to unavailable and incomplete data histories. Hence, when data packets are lost, current and future effective audio playback is hampered. One prior art solution attempting to mitigate this problem bundles large amounts of interdependent data into each data packet. This, however, can result in a single data packet representing a long span of audio data, which, if lost in transmission, can cause unacceptable audio gaps of 200 milliseconds (“ms”) or longer. Even after muting, repeating, and interpolating from surrounding audio data by techniques known in the art, these large gaps can result in audible deterioration that drastically reduce sound quality. For example, speech intelligibility can be altogether impaired.

As a result, many modern A-D converters limit algorithmic dependencies on prior data, allowing encoded data to instead be handled in relatively small, independently decodable units. This presents one lost data packet from effecting surrounding data packets. It also allows compressed data packets to be interleaved, juxtaposing several seconds of data onto neighboring packets. This allows efficient use of large network packets, yet does not create large gaps in decoded audio playback if lost data packets are allowed to only produce many small gaps, spread over several seconds, as opposed to being decoded as a single large gap. The small audio gaps are then compensated using known interpolation techniques, employing both past and future data packets to estimate lost content. The result is that, even under severe packet loss, the D-A converter can produce relatively good audio quality, effectively tolerating up to 15% data losses with relatively minimal audio quality degradation.

Thirdly, scalable audio quality is also often overlooked. To be sure, perceived audio quality of a highly compressed analog signal depends both on the range of the reproduced sound frequencies and the accuracy of representation of the original analog waveform. Thus, one A-to-D converter may achieve a wide frequency response, but sub-optimally reproduce information contained in those frequencies. Conversely, another A-to-D converter may achieve satisfactory playback for a narrow range of frequencies, but sub-optimally reproduce information at the upper or lower ends of the frequency range. Many common A-to-D speech converters typify this problem, whereby frequencies that represent human speech are accurately reproduced, yet the addition of any music that falls outside of the optimal range sounds distorted or is altogether absent. Other commonly available A-to-D converters focus on specific bandwidth targets where distinct audio characteristics are desired. For example, a specific algorithm may be used to produce quality that is transparent to the uncompressed original signal at a low data transfer rate. Hence, if an A-to-D converter yields an audio “sweet-spot” at a specific data transfer rate, using that same encoder at much slower or faster data transfer rate may yield greatly distorted audio playback.

Other encoders strive to not only accurately reproduce audio signals at specific frequencies, but also to achieve relatively broad frequency responses as well, given a specified data transfer rate such as the Internet's 16-32 kbps. Moreover, some codecs dynamically change data transfer rates based on current data requirements. Thus, during musical playback that is particularly difficult to accurately reproduce, these codecs dynamically decrease their frequency response so that extra data can be used to more accurately reproduce the information of the frequencies being reproduced. However, problems persist for web streamers if the bandwidth of the transmission channel changes during transmission, or clients, often having varying receiver resources, join or leave the network during transmission.

What continues to be needed, therefore, are systems and methods that can transmit and receive audio information over a network such as the Internet while utilizing as few bits as possible, yet preserve the best possible quality of sound in an audio sound file. The systems and methods must perform conversions and the scripting of algorithms in the quickest possible time to avoid delay or packet loss that can result in fidelity loss. And they must have the capacity for dealing with the inevitable intermittent losses of data that can and do occur on congested public networks, and all these tasks must be accomplished using a minimum of computing resources.

Further, one must remain mindful that the afore-mentioned A-D converters only work within limited bandwidth restrictions. Thus, in order to execute conversions efficiently, the algorithms allocate limited bits differently according to the complexity of the audio signal. In other words, prior art A-to-D converters are sensitive to complex audio signals. For example, a major factor in the complexity of an audio signal is the dynamic amplitude excursions that occur during the course of the audio playback, such as transitioning from a soft passage in a musical piece to a loud crashing symbol. In response to dynamic intervals such as these, the prior art A-to-D converters decrease the frequency response and allocate more bits to defining the complex waveform. Thus, there may be instances where an A-to-D converter will be forced to exceed the target bandwidth to accommodate a complex waveform, and then later be forced to economize other bits in order to make up the difference, thereby creating distinct audible distortions.

As a result of the foregoing considerations, the inventor conducted unique, experimental testing on the analog signal using professional audio processing techniques. The results of the testing revealed that significant benefits are realized by processing an audio signal before it is encoded by an A-to-D converter, such as enabling the A-to-D converter and D-to-A converter to run more efficiently and effectively, thus yielding higher fidelity outputs. As described subsequently, these techniques improve signal to noise ratio, focus on critical bands, and maximize utilization of the amplitude response allocated by targeted bandwidth parameters. What is described, therefore, is a solution to the above problems that can be implemented efficiently, readily, and cost-effectively.

### BRIEF SUMMARY OF THE INVENTION

By the systems and methods of the present invention, a dynamic audio processor for processing an audio signal prior to encoding is presented. While prior art solutions have focused on processing an audio signal after it is digitialized, the inventive arrangements presented hereby preprocess the audio signal before it is encoded. Specific but non-exhaustive examples of actual and anticipated applications include a web streamer that provides digital data streams from a server. In such an embodiment, the audio signal is desirably delivered such that there is no need to store the entire digital data stream at a client before playback. In any event, the dynamic audio processor and processing methods presented hereby comprise means for and steps of modifying an audio signal into a preferred signal format prior to digitalization thereof. Thus, the systems and methods provide analog-to-analog modification of audio analog input signals. The analog-to-analog modification creates a preferred analog format that is effectively and efficiently converted into the digital data stream by an encoder, such as an A-to-D converter or codec, whereupon, along with other advantages, significant bandwidth can thereby be minimized and saved, for example, for other applications.

In one embodiment, the systems and methods are carried by functional stand-alone components. In an alternative embodiment, the systems and methods are carried as integral components of a PC or other computing platform. In another alternative embodiment, the systems and methods are carried as part of the encoder. In another alternative embodiment, the systems and methods are implemented by providing a codec design in the form of software that is provided to data processing means for providing the encoder and decoder sections of such codec. In addition, the encoder and decoder portion of the codec may be provided in the form of software that is transmitted to an end user prior to receipt of video and audio signal data streams.

In a preferred embodiment, the inventive arrangements receive the analog audio signal input, nominalize the signal to provide a level input, compress the signal according to a pre-set compression ratio, equalize the signal to achieved a desired effect, and nominalize the signal for subsequent outputting thereof.

The foregoing and other objects, advantages, and aspects of the present invention will become apparent from the following description. In the description, reference is made to the accompanying drawings which form a part hereof, and in which there is shown, by way of illustration, a preferred embodiment of the present invention. Such embodiment does not represent the full spirit or scope of the invention, however, and reference must also be made to the claims herein for properly interpreting the spirit and scope of this invention.

### BRIEF DESCRIPTION OF THE SEVERAL VIEWS OF THE DRAWINGS

FIG. 1 is a simplified streaming environment in which a preferred embodiment of the present invention may be practiced;

FIG. 2 is a functional block diagram depicting various embodiments of the present invention;

FIG. 3 is a representative embodiment of various front panel controls for the dynamic audio processor of the present invention;

FIG. 4 is a representative embodiment of various back panel controls for the dynamic audio processor of the present invention; and

FIG. 5 is a representative flow chart depicting various embodiments by which the various methods of the present invention may be practiced.

### DETAILED DESCRIPTION OF THE INVENTION

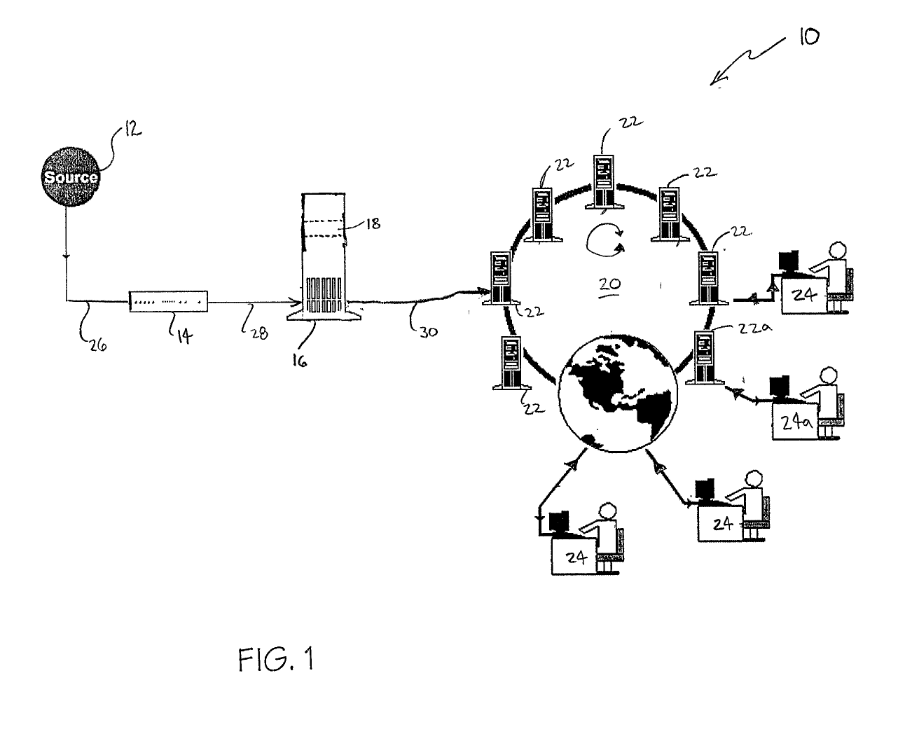

Referring now to FIG. 1, a simplified streaming media environment 10 is depicted in which preferred embodiments of the present invention may be practiced. More specifically, an audio source 12 is in electronic communication with the inventive Digital Audio Processor (“DAP”) 14 of the present invention, which is also preferably in electronic communication with a PC 16 or other computing platform such as a PDA. Alternatively, the DAP 14 is an integral component of the PC 16, for example, fitting into a well-known 5¼ inch drive bay 18 thereof. The PC 16 preferably contains therein an encoder, such as an A-D converter or codec (not shown), for encoding audio signals into a digital data stream. Alternatively, the DAP 14 is an integral component of the encoder. In any event, the PC 16 is preferably in electronic communication with a client-server environment 20 comprising one or more servers 22 that are preferably in electronic communication with one another and also with one or more end users 24. Representative client-server environments 20 include, for example, a LAN, WAN, the public Internet, a wireless network, and other client-server environments 20 and other networks.

As known, when a representative end user 24a clicks on a hyperlink to a streaming sound file displayed by the end user's 24 Web browser, that hyperlink does not directly activate the desired sound file. Rather, the Web browser contacts a server related to that hyperlink, which sends a metafile back to the Web browser. A metafile is a relatively small text file containing the address—i.e., the Uniform Resource Locator (“URL”)—the desired sound file and instructions that tell the Web browser to launch a sound player installed by the end user 24. Representative sound players include, for example, well-known streaming players, such as RealPlayer available from RealNetworks, Inc. of Seattle, Wash. and Windows Media Player available from Microsoft Corp. of Redmond, Wash., installed by the end user 24. In any event, the Web browser then launches the sound player and contacts the server identified in the URL, such as representative server 22a, which is a streaming media distribution server designed to deliver sound files to the end user's 24 sound player. The end user's 24 sound player is generally enabled by a sound card that comprises a decoder, such as a D-A converter or codec (not shown) for decoding the digital data stream into audio signals for streaming playback. The decoded sound files thus create audible sound waves delivered to the end user 24 through speakers (not shown).

More specifically, the audio source 12 provides an audio signal 26 to the DAP 14. Referring generally, the audio source 12 is one or more of the following: a live source; phonographic playback, magnetic tape playback, CD playback, or another type of playback; a traditional or internet radio broadcast or rebroadcast, or another type of broadcast; a television, satellite, cable, or telephonic transmission of an audio signal 26, or another type of transmission; voice applications, including, for example, but not by way of limitation, so called “voice-over” applications including Internet telephony and the like; music applications; combination voice and music applications; and otherwise. Accordingly, the audio signal 26 is generally one of more of the following: a dynamic analog audio signal; a monophonic audio signal (i.e., involving a single transmission path); a stereophonic audio signal (i.e., involving multiple transmission paths); an audio signal extracted from a composite video signal comprising one or more audio signals; or otherwise.

As elaborated upon subsequently, an unspecified audio signal 28 is output from the DAP 14 and input into the encoder of the PC 16. Preferably, the encoder then digitializes the modified audio signal 28 into a digital data stream 30. In one preferred embodiment, the digital data stream 30 is encoded for streaming broadcast into the client-server environment 20, the PC 16 preferably containing the means for stream broadcasting the digital data stream 30 as previously described.

Like the audio signal 26 input to the DAP 14, the modified audio signal 28 output therefrom remains an analog audio signal. However, the DAP 14 processes the original audio signal 26 to enhance its subsequent encoding by the encoder. In other words, the DAP 14 processes the audio signal 26 to create the modified audio signal 28 so that the latter is more effectively and efficiently converted into the digital data stream 30 by the encoder of the PC 16. The modified audio signal 28 thus comprises a preferred signal format for digitalization. In addition, significant bandwidth is thereby saved by the present inventive arrangements, which are embodied as an integral component of the encoder in one preferred embodiment.

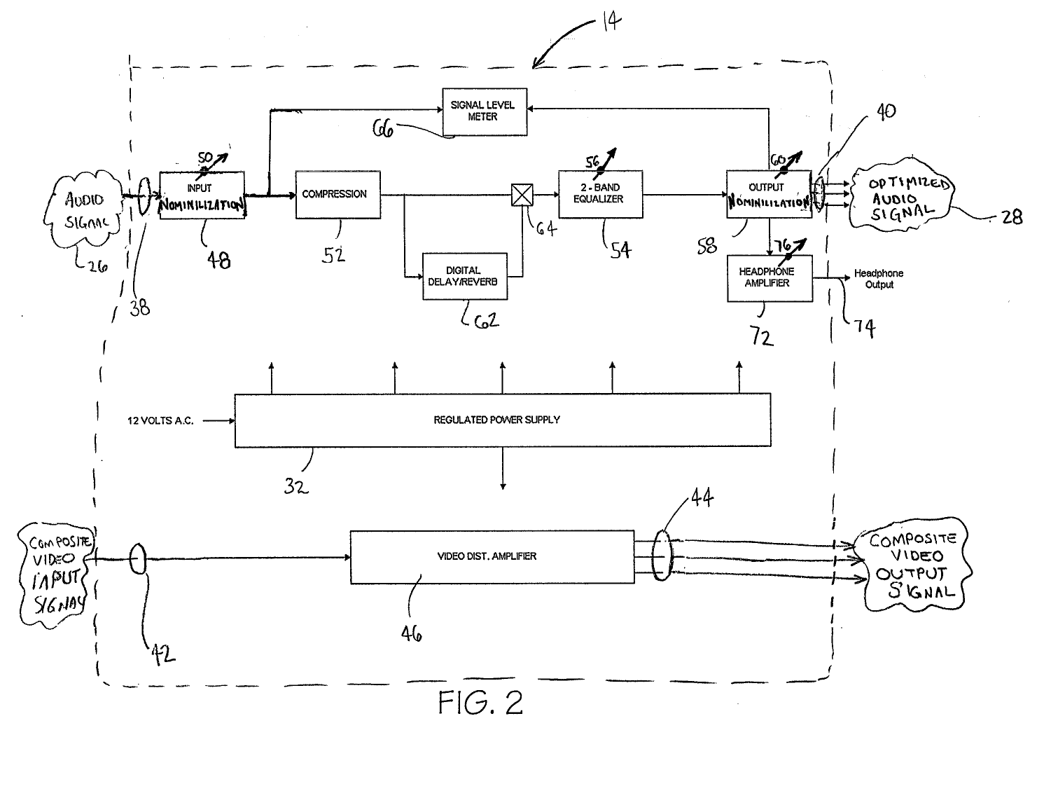

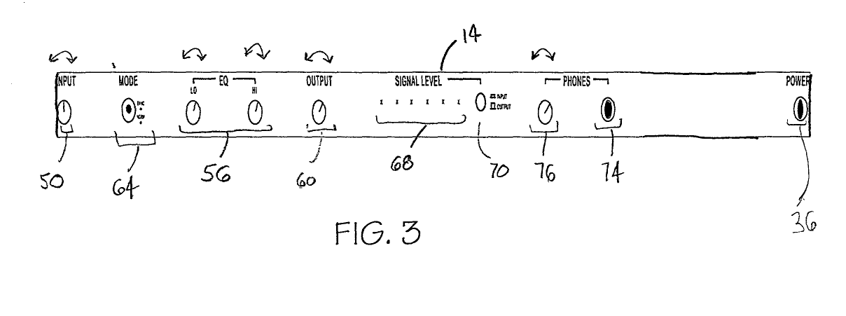

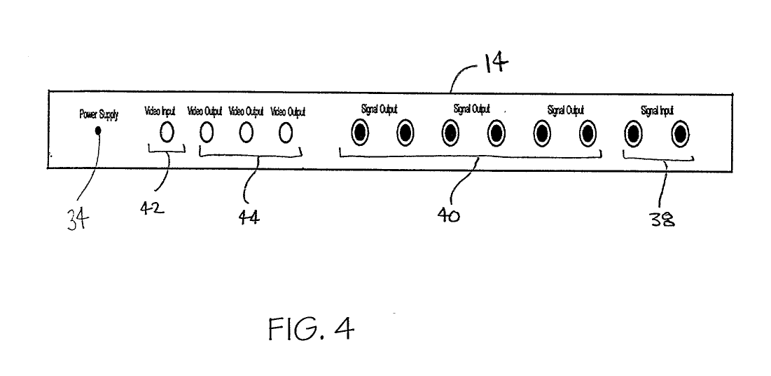

In accord with the foregoing, the functionality of the DAP 14 is representatively depicted in FIGS. 2-4, in which like numerals refer to like elements, as will be elaborated upon shortly. The inventive arrangements can be realized in hardware, software, or a combination thereof. For instance, any hardware, software, or combination thereof adapted or otherwise configured for carrying out the systems and methods described herein, is suited. For instance, the methods may be carried out in software for performing the described steps, or alternatively, by hardware that carries out the described functionalities, as known to persons skilled in such respective arts. For example, the DAP 14 is preferably powered by a 12 volt A.C. regulated power supply 32 that is in electronic communication therewith through a power supply input 34 and triggered, for example, by a power toggle switch 36. It comprises means for receiving the audio signal 38, including, for example, standard ¼ inch stereo signal input jacks. Preferably, but not by way of limitation, the means for receiving the audio signal 38 has a fixed input impedance of about 50 k Ohms. The DAP 14 also comprises means for outputting the modified audio signal 40, including, for example, standard ¼ inch stereo signal output jacks. In a preferred embodiment, the means for outputting the modified audio signal 40 comprises a plurality of output channels such as three output channels. Preferably, but also not by way of limitation, the means for outputting the modified audio signal 40 has a fixed input impedance of about 470 Ohms.

In addition, the DAP 14 also preferably comprises means for receiving a video signal 42, including, for example, National Television Standards Committee (“NTSC”) video input jacks. By known techniques, one or more audio signals can be extracted from a composite video signal to comprise the audio signal 26 for input into the DAP 14. As such, the means for receiving the video signal 42 is preferably in electronic communication with the means for receiving the audio signal 38. In addition, the DAP 14 also comprises means for outputting the video signal 44, including, for example, NTSC video output jacks. In a preferred embodiment, the means for outputting the video signal 44 comprises a plurality of output channels such as three output channels, and are preferably electronic communication with means for outputting the audio signal 40. Also, in electronic communication with the means for receiving the video signal 42 and the means for outputting the video signal 44, the DAP 14 also preferably comprises means for amplifying the video signal 46, such as a video distribution amplifier 46, which is also preferably powered by the regulated power supply 32. When so embodied, significant bandwidth is thereby saved by the present inventive arrangements, including, for example, additional bandwidth available for the composite video signal as saved bandwidth from the audio signal 26.

Referring more specifically to FIG. 2, the DAP 14 receives the audio signal 26 at the means for receiving the audio signal 38. Thereafter, the DAP 14 nominalizes the audio signal 26. Means for nominalizing the audio signal 48 includes means for amplifying the audio signal—such as an input amplifier with positive gain—as well as the same or additional means for attenuating the audio signal—such as an input amplifier with negative gain. Preferably, the audio signal 26 is nominalized according to a pre-defined threshold. A preferred pre-defined level threshold comprises, for example, a pre-defined level input ranging from about −20 dBu to about +6 dBu. A preferred pre-defined level input comprises, for example, a level line input of about −10 dBu nominal for a stereophonic input audio signal 26. This means for nominalizing the audio signal 48 provides a nominalized level audio signal 26 to the remainder of the DAP 14, although hereinout, the processed audio signal 26 is still generally referred to, for simplicity, as the audio signal 26. In a preferred embodiment, the means for nominalizing the audio signal 48 nominalizes the audio signal 26 according to a characteristic of the audio signal 26. For example, a preferred characteristic of the audio signal comprises the voltage of the audio signal 26. Thus, the means for nominalizing the audio signal 48 is preferably signal-level dependent and voltage-level dependent, preferably nominalizing the audio signal 26 to about −10 dBu nominal. To accomplish this nominalization, a preferred embodiment of the DAP 14 includes a level detector (not shown) in electronic communication with a voltage-controlled amplifier (not shown). Finally, the means for nominalizing the audio signal 48 is preferably user-adjustable by input means 50 to achieve a desired effect. Circuitry to carry out the described functionalities, if known to persons skilled in the art, are not needlessly disclosed hereunder.

Next, the DAP 14 includes means for compressing the audio signal 52 that is in electronic communication with the means for nominalizing the audio signal 48. Referring generally, compression “squeezes” a relatively large audio signal into a relatively small signal space. For example, if the dynamic range of the original audio signal 26 exceeds the dynamic range of the DAP 14, compression enables the audio signal 26 to fit within the processing limits of the DAP 14. Compression is generally expressed as a “compression ratio” that describes how much the output of the audio signal changes in relation to how much the input changes. Without compression, for example, doubling the original audio signal 26 would correspondingly double the modified audio signal 28. Such a 1:1 compression ratio implies that a change of +1 dBu at the input produces a corresponding change of +1 dBu at the output. Maximum or infinite compression, on the other hand, expressed as a ∞:1 compression ratio, suggests that the modified audio signal 28 does not change regardless of changes in the original audio signal 26. In the middle, a compression ratio of 4:1 suggests that the modified audio signal 28 changes one quarter as much as the original audio signal 26. Thus, at a compression ratio of 4:1, a +4 dBu change in the original audio signal 26 yields a +1 dBu change in the modified audio signal 28, thereby reducing the dynamic range of the original audio signal 26 by a fourth without significant distortion thereof. In addition, “attack time” measures the amount of time it takes for full compression to be realized after an audio signal is within a given threshold. Fast attack times, for example, abruptly compress the audio signal after the audio signal falls within the threshold, thereby making the initial attack of an instrumental note, for example, sound dull. Similarly, “release time” measures the amount of time it takes to return to 1:1 compression after an audio signal is no longer within a given threshold. Fast release times, for example, abruptly arrest compression of the audio signal after the audio signal falls outside the threshold, thereby hastening, for example, the fade of an instrumental note.

In a preferred embodiment, the DAP 14 compresses the audio signal 26. Preferably, the audio signal 26 is compressed according to a pre-defined compression ratio. A preferred pre-defined compression ratio comprises, for example, a compression ratio ranging from about 10:1 to about 2:1. In addition, a preferred pre-defined compression ratio comprises, for example, a compression ratio of about 4:1 at +6 dBu. This means for compressing the audio signal 52 provides a compressed audio signal 26 to the remainder of the DAP 14. In a preferred embodiment, the means for compressing the audio signal 52 compresses the audio signal 26 according to a characteristic of the audio signal 26. For example, a preferred characteristic of the audio signal 26 is the voltage of the audio signal 26. Thus, the means for compressing the audio signal 52 is preferably signal-level dependent and voltage-level dependent, preferably compressing the audio signal 26 according to the pre-defined compression ratio when the audio signal falls within the pre-defined threshold. To accomplish this compression, a preferred embodiment of the DAP 14 includes a level detector (not shown) in electronic communication with a voltage-controlled compressor (not shown). Once the audio signal 26 is within the compression threshold, it is also preferably compressed according to a pre-defined attack time. A preferred pre-defined attack time comprises, for example, an attack time ranging from about 1 second to about 200 ms, preferably about 500 ms. Similarly, once the audio signal 26 is not within the compression threshold, it is preferably decompressed according to a pre-defined release time. A preferred pre-defined release time comprises, for example, a release time ranging from about 300 ms to about 50 ms, preferably about 150 ms.

Next, the DAP 14 includes means for equalizing the audio signal 54 that is in electronic communication with the means for compressing the audio signal 52. Referring generally, equalizing changes the frequency response of a signal. For example, equalization enables a system to correct for unequal frequency responses, such as by adding or subtracting, for example, more or less response at indicated frequencies. Bass and treble controls are common equalizers, the combination of which are used depending upon, among other things, the type of audio input 26.

In a preferred embodiment, the DAP 14 equalizes the audio signal 26. The means for equalizing the audio signal 54 provides an equalized audio signal 26 to the remainder of the DAP 14. To accomplish this equalization, a preferred embodiment of the DAP 14 includes a multi-band equalizer, such as, for example, a two-band shelving equalizer for attenuating high frequencies and low frequencies, preferably equalizing the audio signal 26 at about +3 dBu at about 80 Hz and about +4 dBu at about 12,000 Hz. In an alternative embodiment, the two-band shelving equalizer equalizes the audio signal 26 at about +3 dBu at about 12,000 Hz and about −3 dBu at about 80 Hz, for example, for a primarily voice audio signal 26. Thus, the means for equalizing the audio signal 54 is preferably user-adjustable by input means 56 to achieve a desired effect. Referring generally, a shelving equalizer raises or lowers an entire range of frequencies above or below a specified level.

Next, the DAP 14 includes means for nominalizing the audio signal 58 that is in electronic communication with the means for equalizing the audio signal 54. The means for nominalizing the audio signal 58 includes means for amplifying the audio signal—such as an input amplifier with positive gain—as well as the same or additional means for attenuating the audio signal—such as an input amplifier with negative gain. Preferably, the audio signal 26 is nominalized according to a pre-defined threshold. A preferred pre-defined threshold comprises, for example, a pre-defined level input. A preferred pre-defined level input comprises, for example, a level input ranging from about +1 dBu to about −10 dBu. In addition, a preferred pre-defined level input comprises, for example, a level input of about −10 dBu nominal for a stereophonic input audio signal 26. The means for nominalizing the audio signal 58 provides a nominalized level audio signal 26 from the DAP 14, as expected, for example, at a downstream encoder. In a preferred embodiment, the means for nominalizing the audio signal 58 nominalizes the audio signal 26 according to a characteristic of the audio signal 26. A preferred characteristic of the audio signal 26 comprises, for example, the voltage of the audio signal 26. Thus, the means for nominalizing the audio signal 58 is preferably signal-level dependent and voltage-level dependent, preferably nominalizing the audio signal 26 to about −10 dBu nominal. To accomplish this nominalization, a preferred embodiment of the DAP 14 includes a level detector (not shown) in electronic communication with a voltage-controlled amplifier (not shown). Finally, the means for nominalizing the audio signal 58 is preferably user-adjustable by input means 60 to achieve a desired effect.

In addition, the DAP 14 preferably includes means for enhancing the audio signal 62 that is in electronic communication with the means for compressing the audio signal 52 and the means for equalizing the audio signal 54. In this preferred embodiment, the means for enhancing the audio signal 62 comprises means for decreasing reverberation in the audio signal 26, for example, by introducing a time delay to accommodate voice audio signals 26. Finally, the means for enhancing the audio signal 62 is preferably user-adjustable by input means 64 to achieve a desired effect, such as a toggle switch. For example, with a musical audio signal 26, the means for enhancing the audio signal 62 is preferably toggled off.

In addition, the DAP 14 preferably includes means for monitoring the audio signal 66 that is in electronic communication with the first means for nominalizing the audio signal 48, the means for compressing the audio signal 52, and the second means for nominalizing the audio signal 58. In a preferred embodiment, the means for monitoring the audio signal 66 comprises one or more signal level indicators 68, such as light-emitting diodes, and input means 70 to select between the first and second means for nominalizing the audio signal 48, 58, such as a toggle switch. The signal level indicators 68 are preferably also used with the input means 50 used to achieve the desired effect with the first means for nominalizing the audio signal 48, and also the input means 60 used to achieve the desired effect with the second means for nominalzing the audio signal 58, so as to ensure an undistorted audio signal 26 is output from the DAP 14, as adjusted by a user.

In addition, the DAP 14 preferably includes means for amplifying the audio signal 72 that is in electronic communication with the second means for nominalizing the audio signal 58, such as, for example, a headphone amplifier, to selectively and audibly adjust the functionalities as desired above. Accordingly, the DAP 14 also preferably includes means for outputting the audio signal 74 that is in electronic communication with the means for amplifying the audio signal 72, such as for example, a standard ¼ inch headphone output jack and input means 76 used to achieve a desired volume level.

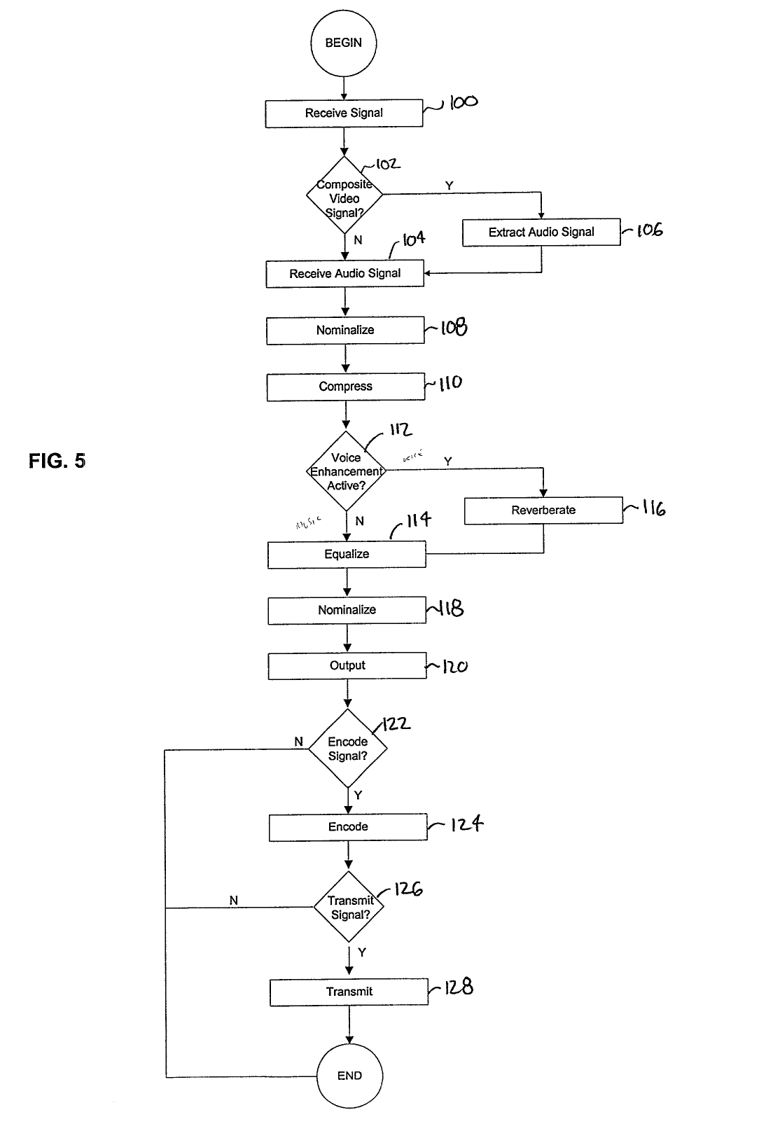

Referring now to FIG. 5, various embodiments by which the various methods of the present invention may be practiced are depicted, substantially as described above. More specifically, the methods begin in step 100, wherein the analog signal is received from an analog source. From step 100, control passes to step 102, wherefrom control passes to step 104 if the received signal is not a composite video signal. On the other hand, if the received signal is a composite video signal, control passes from step 102 to step 106, where the audio signal is extracted from the composite video signal before control passes to step 104. Thus, in a preferred embodiment, control passes from step 102 to step 104 if the received signal is not a composite video signal; otherwise, control passes from step 102 to step 106 if the received signal is a composite video signal. In any event, the audio signal is received in step 104.

From step 104, control passes to step 108, where the received signal is preferably nominalized. From step 108, control passes to step 110, where the nominalized signal is compressed. From step 110, control passes to step 112, wherefrom control passes to step 114 if voice enhancement is not active. Otherwise, control passes from step 112 to step 116, where the compressed signal is reverberated before control is passed to step 114. Thus, in a preferred embodiment, control passes from step 112 to step 114 if the received signal is primarily a musical signal; otherwise, control passes from step 112 to step 116 if the received signal is primarily a voice signal. In any event, the compressed signal is equalized in step 114.

From step 114, control passes to step 118, where the equalized signal is preferably nominalized. From step 118, control passes to step 120, where the nominalized signal is output. From step 120, control passes to step 122, wherefrom control passes to step 124 if the output signal is to be encoded. Otherwise, the method of the present invention terminates after step 122. In step 124, the output signal is encoded. From step 124, control passes to step 126, wherefrom control passes to step 128 if the encoded signal is to be transmitted, for example, into a client-server environment 20. Otherwise, the method of the present invention terminates after step 126. In step 128, the encoded signal is transmitted, after which the method of the present invention terminates.

The spirit and scope of the present invention is not limited to any of the various embodiments described above. Rather, details and features of exemplary and preferred embodiments have been disclosed. Without departing from the spirit and scope of this invention, other modifications will therefore be apparent to those skilled in the art. Thus, it must be understood that the detailed description of the invention and drawings were intended as illustrative only, and not by way of limitation.

What is claimed is:

1. A processor for processing an audio signal prior to encoding said audio signal, said processor comprising means for modifying said audio signal to a preferred signal format for digitalization.

2. The processor of claim 1 wherein said preferred signal format comprises a modified audio signal based on said audio signal.

3. A processor for processing an audio signal prior to encoding said audio signal, said processor comprising:
means for receiving said audio signal;
first means for nominalizing said audio signal, said first means for nominalizing said audio signal in electronic communication with said means for receiving said audio signal;
means for compressing said audio signal, said means for compressing said audio signal in electronic communication with said first means for nominalizing said audio signal;
means for equalizing said audio signal, said means for equalizing said audio signal in electronic communication with said means for compressing said audio signal;
second means for nominalizing said audio signal, said second means for nominalizing said audio signal in electronic communication with said means for equalizing said audio signal; and
means for outputting said audio signal, said means for outputting said audio signal in electronic communication with said second means for nominalizing said audio signal.

4. The processor of claim 3 wherein said audio signal comprises an analog signal.

5. The processor of claim 3 wherein said audio signal comprises a monophonic signal.

6. The processor of claim 3 wherein said audio signal comprises a stereophonic signal.

7. The processor of claim 3 wherein said audio signal was extracted from a composite video signal, said composite video signal comprising said audio signal.

8. The processor of claim 3 wherein said system is powered by a 12 volt A.C. regulated power supply in electronic communication therewith.

9. The processor of claim 3 wherein said means for receiving said audio signal has an input impedance of about 50 k Ohms.

10. The processor of claim 3 wherein said first means for nominalizing said audio signal operates to nominalize said audio signal in accordance with a characteristic of said audio signal.

11. The processor of claim 10 wherein said characteristic comprises a voltage of said audio signal.

12. The processor of claim 3 wherein said first means for nominalizing said audio signal is user-adjustable.

13. The processor of claim 3 wherein said first means for nominalizing said audio signal operates to nominalize said audio signal according to a pre-defined threshold.

14. The processor of claim 13 wherein said pre-defined threshold comprises a pre-defined level input.

15. The processor of claim 14 wherein said pre-defined level input ranges from about −20 dBu to about +6 dBu.

16. The processor of claim 15 wherein said pre-defined level input is about −10 dBu nominal.

17. The processor of claim 3 wherein said first means for nominalizing said audio signal comprises means for amplifying said audio signal.

18. The processor of claim 3 wherein said first means for nominalizing said audio signal comprises means for attenuating said audio signal.

19. The processor of claim 3 wherein said means for compressing said audio signal operates to compress said audio signal in accordance with a characteristic of said audio signal.

20. The processor of claim 19 wherein said characteristic comprises a voltage of said audio signal.

21. The processor of claim 3 wherein said means for compressing said audio signal operates to compress said audio signal according to a pre-defined compression ratio.

22. The processor of claim 21 wherein said pre-defined compression ratio ranges from about 10:1 to about 2:1.

23. The processor of claim 22 wherein said pre-defined compression ratio is about 4:1 at +6 dBu.

24. The processor of claim 3 wherein said means for compressing said audio signal operates to compress said audio signal according to a pre-defined attack time.

25. The processor of claim 24 wherein said pre-defined attack time ranges from about 1 second to about 200 ms.

26. The processor of claim 25 wherein said pre-defined attack time is about 500 ms.

27. The processor of claim 3 wherein said means for compressing said audio signal operates to compress said audio signal according to a pre-defined release time.

28. The processor of claim 27 wherein said pre-defined release time ranges from about 300 ms to about 50 ms.

29. The processor of claim 28 wherein said pre-defined release time is about 150 ms.

30. The processor of claim 3 wherein said means for equalizing said audio signal comprises a multi-band equalizer.

31. The processor of claim 30 wherein said multi-band equalizer comprises a two-band shelving equalizer for attenuating high and low frequencies.

32. The processor of claim 31 wherein said two-band shelving equalizer operates to equalize said audio signal at about +3 dBu at about 80 Hz and about +4 dBu at about 12,000 Hz.

33. The processor of claim 30 wherein said multi-band equalizer is user-adjustable.

34. The processor of claim 3 wherein said second means for nominalizing said audio signal operates to nominalize said audio signal in accordance with a characteristic of said audio signal.

35. The processor of claim 34 wherein said characteristic comprises a voltage of said audio signal.

36. The processor of claim 3 wherein said second means for nominalizing said audio signal is user-adjustable.

37. The processor of claim 3 wherein said second means for nominalizing said audio signal operates to nominalize said audio signal according to a pre-defined threshold.

38. The processor of claim 37 wherein said pre-defined threshold comprises a pre-defined level input.

39. The processor of claim 38 wherein said pre-defined level input ranges from about −1 dBu to about +10 dBu.

40. The processor of claim 39 wherein said pre-defined level input is about −10 dBu nominal.

41. The processor of claim 3 wherein said second means for nominalizing said audio signal comprises means for amplifying said audio signal.

42. The processor of claim 3 wherein said second means for nominalizing said audio signal comprises means for attenuating said audio signal.

43. The processor of claim 3 wherein said means for outputting said audio signal has an output impedance of about 470 Ohms.

44. The processor of claim 3 wherein said means for outputting said audio signal comprises multiple output channels.

45. The processor of claim 44 wherein said multiple output channels comprise three output channels.

46. The processor of claim 3 further comprising:
means for enhancing said audio signal if said audio signal comprises a voice audio signal, said means for enhancing said audio signal in electronic communication with said means for compressing said audio signal, and also in electronic communication with said means for equalizing said audio signal.

47. The processor of claim 46 wherein said means for enhancing said audio signal comprises means for controlling reverberation.

48. The processor of claim 46 wherein said means for enhancing said audio signal is user-adjustable.

49. The processor of claim 3 further comprising:
means for monitoring said audio signal, said means for monitoring said audio signal in electronic communication with said first means for nominalizing said audio signal, and also in electronic communication with said means for compressing said audio signal, and also in electronic communication with said second means for nominalizing said audio signal.

50. The processor of claim 49 wherein said means for monitoring said audio signal comprises means for monitoring said first means for nominalizing said audio signal.

51. The processor of claim 49 wherein said means for monitoring said audio signal comprises means for monitoring said second means for nominalizing said audio signal.

52. The processor of claim 3 further comprising:
means for amplifying said audio signal, said means for amplifying said audio signal in electronic communication with said second means for nominalizing said audio signal.

53. The processor of claim 52 further comprising:
means for outputting said amplified audio signal, said means for outputting said amplified audio signal in electronic communication with said means for amplifying said audio signal.

54. The processor of claim 53 wherein said means for outputting said amplified audio signal is user-adjustable.

55. The processor of claim 3 further comprising:
means for encoding said audio signal, said means for encoding said audio signal in electronic communication with said means for outputting said audio signal.

56. The processor of claim 55 wherein said means for encoding said audio signal operates to convert said audio signal into a digital data stream.

57. The processor of claim 56 wherein said means for encoding said audio signal comprises an analog-to-digital converter.

58. The processor of claim 56 wherein said means for encoding said audio signal comprises a codec.

59. The processor of claim 56 further comprising:
means for stream broadcasting said digital data stream, said means for stream broadcasting said digital data stream in electronic communication with said means for encoding said audio signal.

60. The processor of claim 59 further comprising:
means for decoding said digital data stream, said means for decoding said digital data stream in electronic communication with said means for stream broadcasting said digital data stream.

61. The processor of claim 60 wherein said means for decoding said digital data stream operates to convert said digital data stream into said audio signal.

62. The processor of claim 61 wherein said means for decoding said digital data stream comprises a digital-to-analog converter.

63. The processor of claim 61 wherein said means for decoding said digital data stream comprises a codec.

64. The processor of claim 3 further comprising:
means for receiving a composite video signal, said means for receiving said composite video signal in electronic communication with said means for receiving said audio signal.

65. The processor of claim 64 further comprising:
means for amplifying said composite video signal, said means for amplifying said composite video signal in electronic communication with said means for receiving said composite video signal.

66. The processor of claim 65 further comprising:
means for outputting said composite video signal, said means for outputting said composite video signal in electronic communication with said means for amplifying said composite video signal.

67. The processor of claim 66 wherein said means for outputting said composite video signal comprises multiple output channels.

68. The processor of claim 67 wherein said multiple output channels comprise three output channels.

69. A method for processing an audio signal prior to encoding said audio signal, said method comprising modifying said audio signal to a preferred signal format for digitalization.

70. The method of claim 69 wherein said preferred signal format comprises a modified audio signal based on said audio signal.

71. A method for processing an audio signal prior to encoding said audio signal, said method comprising steps of:
receiving said audio signal;
first nominalizing said audio signal;
compressing said audio signal;
equalizing said audio signal;
second nominalizing said audio signal; and
outputting said audio signal.

72. The method of claim 71 wherein said audio signal comprises an analog signal.

73. The method of claim 71 wherein said audio signal comprises a monophonic signal.

74. The method of claim 71 wherein said audio signal comprises a stereophonic signal.

75. The method of claim 71 wherein said audio signal was extracted from a composite video signal, said composite video signal comprising said audio signal.

76. The method of claim 71 wherein said step of first nominalizing said audio signal nominalizes said audio signal in accordance with a characteristic of said audio signal.

77. The method of claim 76 wherein said characteristic comprises a voltage of said audio signal.

78. The method of claim 71 wherein said step of first nominalizing said audio signal is user-adjustable.

79. The method of claim 71 wherein said step of first nominalizing said audio signal nominalizes said audio signal according to a pre-defined threshold.

80. The method of claim 79 wherein said pre-defined threshold comprises a pre-defined level input.

81. The method of claim 80 wherein said pre-defined level input ranges from about −20 dBu to about +6 dBu.

82. The method of claim 81 wherein said pre-defined level input is about −10 dBu nominal.

83. The method of claim 71 wherein said step of first nominalizing said audio signal amplifies said audio signal.

84. The method of claim 71 wherein said step of first nominalizing said audio signal attenuates said audio signal.

85. The method of claim 71 wherein said step of compressing said audio signal comprises compressing said audio signal in accordance with a characteristic of said audio signal.

86. The method of claim 85 wherein said characteristic comprises a voltage of said audio signal.

87. The method of claim 71 wherein said step of compressing said audio signal comprises compressing said audio signal according to a pre-defined compression ratio.

88. The method of claim 87 wherein said pre-defined compression ratio ranges from about 10:1 to about 2:1.

89. The method of claim 88 wherein said pre-defined compression ratio is about 4:1 at +6 dBu.

90. The method of claim 71 wherein said step of compressing said audio signal comprises compressing said audio signal according to a pre-defined attack time.

91. The method of claim 90 wherein said pre-defined attack time ranges from about 1 second to about 200 ms.

92. The method of claim 91 wherein said pre-defined attack time is about 500 ms.

93. The method of claim 71 wherein said step of compressing said audio comprises compressing said audio signal according to a pre-defined release time.

94. The method of claim 93 wherein said pre-defined release time ranges from about 300 ms to about 50 ms.

95. The method of claim 94 wherein said pre-defined release time is about 150 ms.

96. The method of claim 71 wherein said step of equalizing said audio signal comprises equalizing said audio signal with a multi-band equalizer.

97. The method of claim 96 wherein said multi-band equalizer comprises a two-band shelving equalizer for attenuating high and low frequencies.

98. The method of claim 97 wherein said two-band shelving equalizer operates to equalize said audio signal at about +3 dBu at about 80 Hz and about +4 dBu at about 12,000 Hz.

99. The method of claim 96 wherein said multi-band equalizer is user-adjustable.

100. The method of claim 71 wherein said step of second nominalizing said audio signal comprises nominalizing said audio signal in accordance with a characteristic of said audio signal.

101. The method of claim 100 wherein said characteristic comprises a voltage of said audio signal.

102. The method of claim 71 wherein said step of second nominalizing said audio signal is user-adjustable.

103. The method of claim 71 wherein said step of second nominalizing said audio signal comprises nominalizing said audio signal according to a pre-defined threshold.

104. The method of claim 103 wherein said pre-defined threshold comprises a pre-defined level input.

105. The method of claim 104 wherein said pre-defined level input ranges from about −1 dBu to about +10 dBu.

106. The method of claim 105 wherein said pre-defined level input is about −10 dBu nominal.

107. The method of claim 71 wherein said step of second nominalizing said audio signal comprises amplifying said audio signal.

108. The method of claim 71 wherein said step of second nominalizing said audio signal comprises attenuating said audio signal.

109. The method of claim 71 wherein said step of outputting said audio signal comprises outputting said audio signal to multiple output channels.

110. The method of claim 109 wherein said multiple output channels comprise three output channels.

111. The method of claim 71 further comprising a step of enhancing said audio signal if said audio signal comprises a voice audio signal.

112. The method of claim 111 wherein said step of enhancing said audio signal comprises controlling reverberation.

113. The method of claim 111 wherein said step of enhancing said audio signal is user-adjustable.

114. The method of claim 71 further comprising a step of monitoring said audio signal.

115. The method of claim 114 wherein said step of monitoring said audio signal comprises monitoring said step of first nominalizing said audio signal.

116. The method of claim 114 wherein said step of monitoring said audio signal comprises monitoring said step of second nominalizing said audio signal.

117. The method of claim 71 further comprising a step of amplifying said audio signal.

118. The method of claim 117 further comprising a step of outputting said amplified audio signal.

119. The method of claim 118 wherein said step of outputting said amplified audio signal is user-adjustable.

120. The method of claim 71 further comprising a step of encoding said audio signal.

121. The method of claim 120 wherein said step of encoding said audio signal comprises converting said audio signal into a digital data stream.

122. The method of claim 121 further comprising a step of stream broadcasting said digital data stream.

123. The method of claim 122 further comprising a step of decoding said digital data stream.

124. The method of claim 123 wherein said step of decoding said digital data stream comprises converting said digital data stream into said audio signal.

125. The method of claim 71 further comprising a step of receiving a composite video signal.

126. The method of claim 125 further comprising a step of amplifying said composite video signal.

127. The method of claim 126 further comprising a step of outputting said composite video signal.

128. The method of claim 127 wherein said step of outputting said composite video signal comprises outputting said composite video signal to multiple output channels.

129. The method of claim 128 wherein said multiple output channels comprise three output channels.
